(19) United States
(12) Patent Application Publication
(10) Pub. No.: US 2015/0085868 A1
(43) Pub. Date: Mar. 26, 2015

(54) Semiconductor with Virtualized Computation and Switch Resources

(71) Applicant: CAVIUM, INC., San Jose, CA (US)

(72) Inventors: Wilson P. Snyder, II, Holliston, MA (US); Muhammad Raghib Hussain, Saratoga, CA (US)

(73) Assignee: CAVIUM, INC., San Jose, CA (US)

(21) Appl. No.: 14/037,245

(22) Filed: Sep. 25, 2013

(51) Int. Cl. H04L 12/931; G06F 9/455

(52) U.S. Cl. CPC H04L 49/354; G06F 9/45533
USPC 370/401

(57) ABSTRACT

A semiconductor substrate has a processor configurable to support execution of a hypervisor controlling a set of virtual machines and a physical switch configurable to establish virtual ports to the set of virtual machines.

### FIELD OF THE INVENTION

This invention relates generally to communications in computer networks. More particularly, this invention is directed toward a semiconductor with virtualized computation and switch resources.

### BACKGROUND OF THE INVENTION

FIG. 1 illustrates a physical host computer 100 executing a plurality of virtual machines 102_1 through 102_N. A virtual machine is a software implementation of a computing resource and its associated operating system. The host machine is the actual physical machine on which virtualization takes place. Virtual machines are sometimes referred to as guest machines. The software that creates the environment for virtual machines on the host hardware is called a hypervisor. The virtual view of the network interface of a virtual machine is called a virtual network interface card with ports vNIC 103_1 through 103_N. A virtual switch 104 implemented in the software of a hypervisor is used to direct traffic from a physical port 106 to a designated virtual machine's vNIC 103 or between two virtual machines (e.g., from 102_1 to 102_N).

A Network Interface Card (NIC) 108 is coupled to the host computer 100 via a physical port 110 (typically a system bus, such as Peripheral Component Interface Express (PCIe)). The NIC 108 has a physical port 112 to interface to a network. Network traffic is processed by a processor 114, which accesses instructions in memory 116. In particular, the processor 114 implements various packet formatting, check, transferring and classification operations.

The prior art system of FIG. 1 is susceptible to processing inefficiencies in the event that a virtual machine is subject to attack (e.g., a distributed denial of service attack). In such an event, the hypervisor consumes a disproportionate number of processing cycles and associated memory bandwidth managing the attacked virtual machine's traffic, which degrades the performance of the other virtual machines. Processing inefficiencies also stem from the large number of tasks in a virtual switch supported by the host computer, especially Quality of Service (QoS) and bandwidth provisioning between virtual machines. An additional impact of such overhead is manifested in terms of latencies added in the network communication.

In view of the foregoing, it would be desirable to provide an improved platform for virtualization operations.

### SUMMARY OF THE INVENTION

A semiconductor substrate has a processor configurable to support execution of a hypervisor controlling a set of virtual machines and a physical switch configurable to establish virtual ports to the set of virtual machines.

A rack has blade resources wherein each blade resource has semiconductor resources, wherein each semiconductor resource includes a semiconductor substrate with a processor configurable to support execution of a hypervisor controlling a set of virtual machines and a physical switch configurable to establish virtual ports to the set of virtual machines.

### BRIEF DESCRIPTION OF THE FIGURES

The invention is more fully appreciated in connection with the following detailed description taken in conjunction with the accompanying drawings, in which:

FIG. 1 illustrates a prior art computer host and network interface card system.

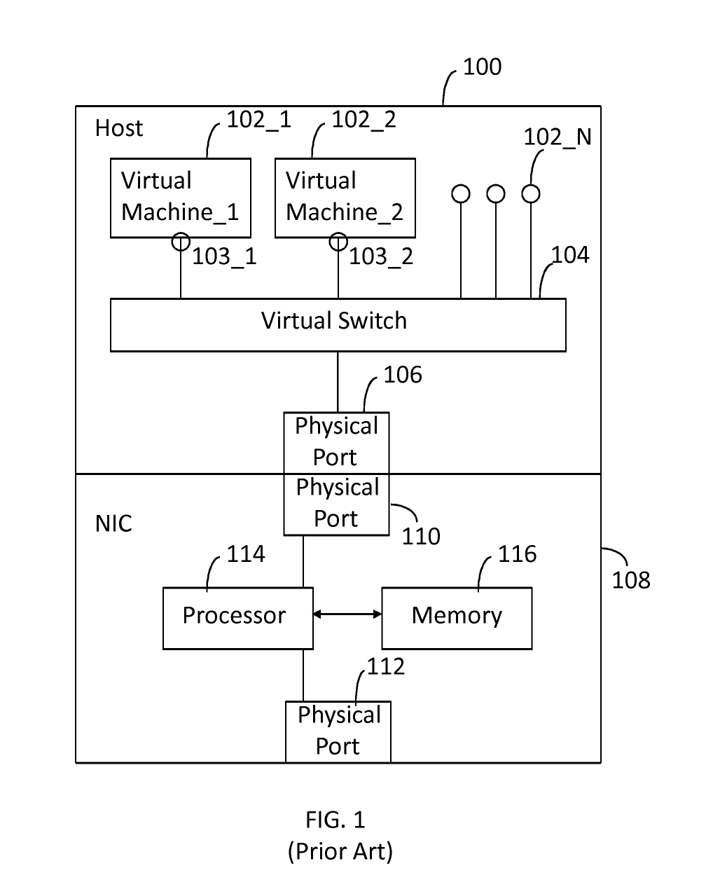

FIG. 2 illustrates a semiconductor based virtualized computation and switch resource.

FIG. 3 is a more detailed characterization of the resource of FIG. 2.

FIG. 4 illustrates ports associated with the semiconductor based virtualized computation and switch resource.

FIG. 5 illustrates a server blade incorporating the virtualized computation and switch resources of the invention.

FIG. 6 illustrates a data center rack constructed with server blades utilizing the virtualized computation and switch resources of the invention.

FIG. 7 illustrates incoming flow processing performed in accordance with an embodiment of the invention.

FIG. 8 illustrates outgoing flow processing performed in accordance with an embodiment of the invention.

Like reference numerals refer to corresponding parts throughout the several views of the drawings.

### DETAILED DESCRIPTION OF THE INVENTION

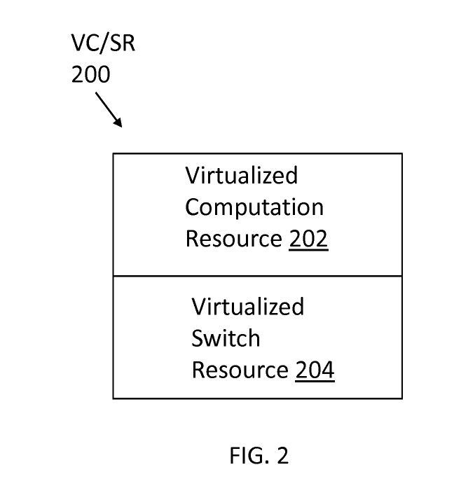

FIG. 2 illustrates a virtualized computation/switch resources (VC/SR) 200 implemented on a single semiconductor substrate. The VC/SR 200 has virtualized computation resource 202 and virtualized switch resource 204. Thus, on a single semiconductor substrate computation resources, such as those typically associated with a host 100 are available. In addition, switch resources, such as those typically associated with a standalone switch are available.

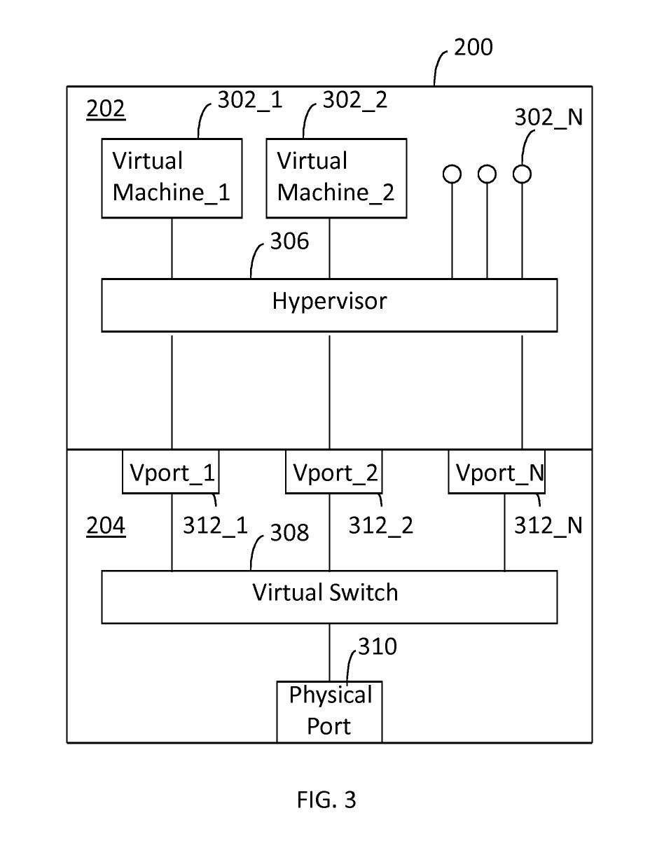

FIG. 3 illustrates virtualized computation resource 202 executing a set of virtual machines 302_1 through 302_N under the control of a hypervisor 306. The virtualized computation resource 202 includes one or more processor cores and associated memory. The computation resource 202 has on-chip memory and ports to access off-chip memory. The memory stores the software for the hypervisor, virtual machine applications and data used by them. A hypervisor can be a pure software implementation, a hardware implementation or a combination of software and hardware.

Virtualized switch resource 204 is coupled to the virtualized computation resource 202. The virtualized switch resource 204 implements a virtual switch 308. The virtual switch 308 receives network traffic from a physical port 310 and directs it to a designated virtual machine, which is accessed through a corresponding virtual port 312. That is, each virtual port or virtual network card 312 has a corresponding virtual machine. The virtual switch 308 directs traffic to a virtual port (e.g., 312_2), which results in the corresponding virtual machine (e.g., 302_2) receiving the traffic. The virtual switch includes a physical switch (e.g., a 1-to-n port switch, an m-to-n port switch) with virtualized resources to establish a relationship between virtual ports and physical ports. That is, the virtual ports are implemented across one or more physical interfaces. The physical interface may be system buses or one or more Peripheral Component Interface Express (PCIe) ports. The virtual switch 308 maps a virtual port or virtual network card 312 to a physical port or physical network link.

An advantage of this architecture is the close coupling between the virtualized computation resource 202 and the virtualized switch resource 204, which provides an efficient sharing of physical input/output resources by the virtual computation resources. Another advantage of this architecture is that the one-to-one correspondence between a virtual machine and its virtual network port results in fine grained control and management of physical input/output port bandwidth and traffic classification for virtual computing resources without overhead on computing resources.

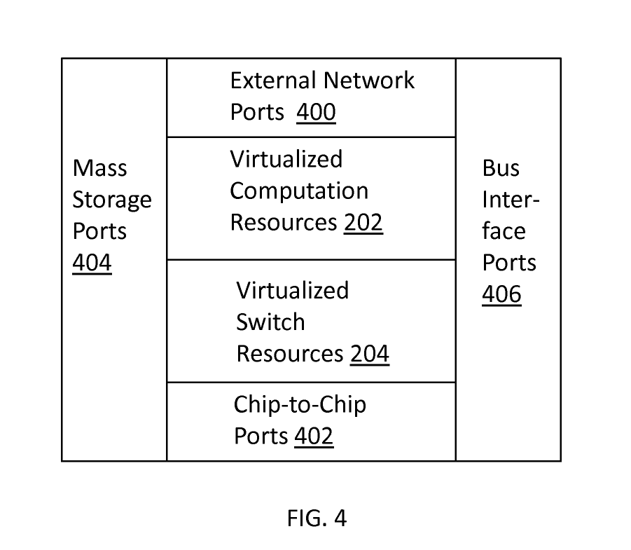

FIG. 4 illustrates ports associated with the virtualized computation resource 202 and virtualized switch resource 204. In one embodiment, there is a set of external network ports 400, which may be used for communicating with an external network. A set of chip-to-chip ports 402 are also provided for communicating between individual VC/SRs 200. Mass storage ports 404 are also supplied for links to mass storage devices, such as disk drives, optical drives and Flash memory drives. The mass storage ports 404 may be Serial Advanced Technology Attachment (SATA) ports. Bus interface ports 406 may also be used. The bus interface ports may provide serial bus interfaces, such as PCIe.

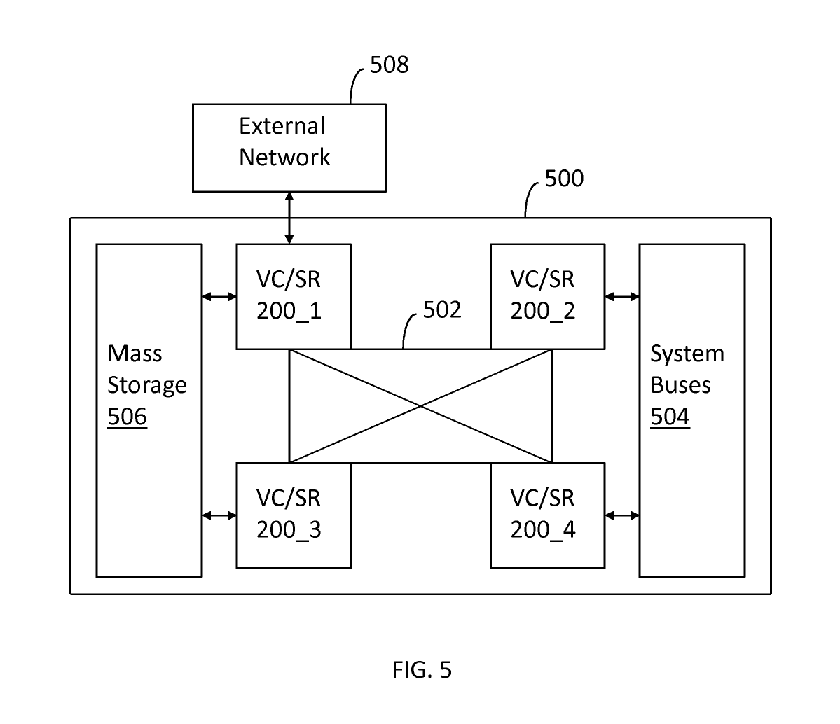

FIG. 5 illustrates a server blade 500 incorporating a set of VC/SRs 200_1 through 200_4. The VC/SRs 200 are interconnected through chip-to-chip ports 402, as shown with connections 502. Individual VC/SRs (e.g., 200_1, 200_2) are coupled to mass storage 506 through mass storage ports 404. Individual VC/SRs (e.g., 200_2, 200_4) are coupled to system buses 504 through bus interface ports 406. At least one VC/SR (e.g., 200_1) is coupled to an external network 508 via external network ports 400.

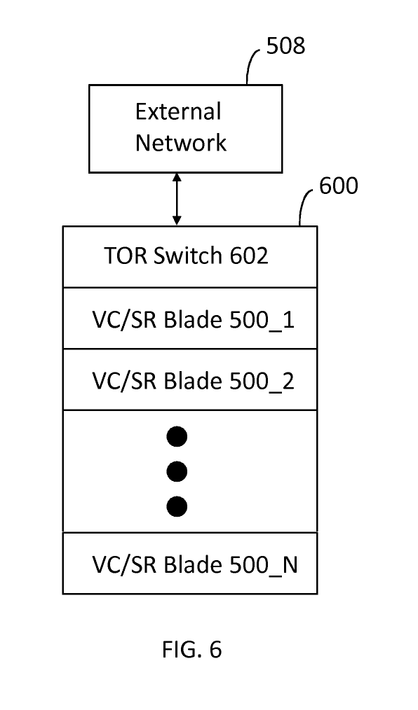

FIG. 6 illustrates a data center rack or chassis 600 holding a set of VC/SR blades 500_1 through 500_N. A top of rack (TOR) switch 602 may be used for coupling to an external network 508. Alternately, the TOR switch 602 may be omitted with the rack 600 relying solely upon the virtualized switch resources of the individual blades 500 for communicating with the external network 508.

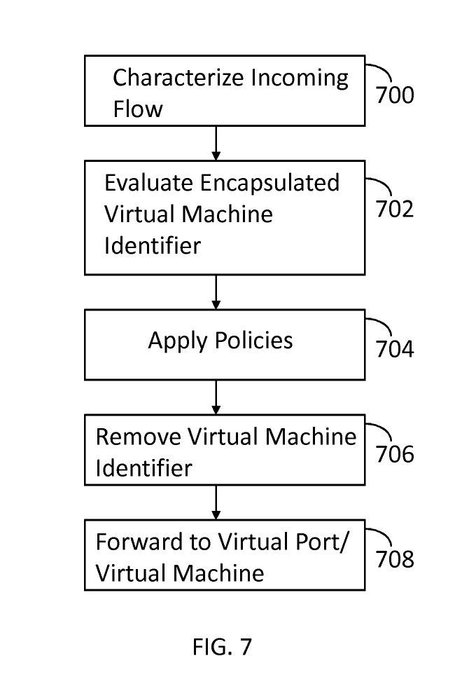

FIG. 7 illustrates incoming network traffic processing. Initially, an incoming flow is characterized 700. Characterization may be based upon any number of factors, such as input port, Virtual Local Area network identification (VLAN ID), Ethernet source Media Access Control (MAC) address, Internet Protocol (IP) Source MAC address, IP Destination MAC address, Transmission Control Protocol (TCP) source or destination port, User Datagram Protocol (UDP) source or destination port and the like. In addition to these standard elements, the invention utilizes a virtual machine identifier. In particular, a Virtual Extensible LAN (VXLAN) identifier may be used. VXLAN is a network virtualization technology that uses an encapsulation technique to encapsulate MAC-based layer 2 Ethernet frames within layer 3 UDP packets. The encapsulated virtual machine identifier is evaluated 702. The identifier may also be something unique and specific to an experimental/custom protocol as defined by software defined networking. The identifier is used to route the flow to the appropriate virtual machine via its corresponding virtual network or virtual port. Each virtual network may have the same network address. The VXLAN identifier or the like specifies the virtual network to which a packet belongs.

Prior to routing, the VC/SR may apply one or more traffic flow policies 404, as discussed below. The virtual machine identifier is used as an index into a flow table array that has one or more policy entries to specify what to do with the packet. In one embodiment, the virtual switch implements bandwidth provisioning aspects of a data plane of a software defined networking (SDN) switch. If an entry is not found in the flow table, then an exception is thrown and the Open Flow controller of an equivalent utility in the Linux® user space is used for slow path processing.

Afterwards, the virtual machine identifier is removed 706 and the packet is forwarded to the appropriate virtual port or virtual network card for delivery to the virtual machine corresponding to that virtual port or virtual network card 708.

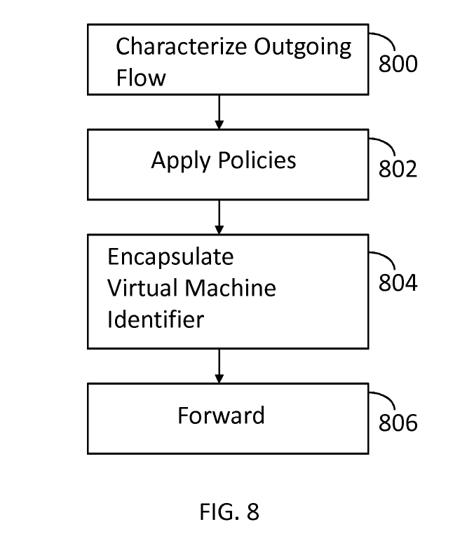

FIG. 8 illustrates outgoing network traffic processing. Initially, outgoing network traffic is characterized 800. The criteria specified above for an incoming flow may be used for the outgoing flow. Policies are then applied 802. The virtual machine identifier is then encapsulated in the packet 804. Finally, the packet is forwarded 806. The packet may be forwarded to a physical port. Alternately, the packet may be forwarded to another virtual port or virtual network card without encapsulation. Thus, effectively, virtual machine to virtual machine traffic is switched without reaching the physical network.

The VC/SR may be configured to enforce various traffic management policies. For example, VC/SR may check for bandwidth provisions. If such provisions exist for a given user, then the provision policy is enforced. For example, a specific user, flow, application or device may be limited to a specified amount of bandwidth at different times. The provision policy may implement bandwidth provisioning for such a user, flow application or device.

The VC/SR may also be configured to check for a Quality of Service (QoS) policy. The QoS policy may provide different priority to different users, flows, applications or devices. The QoS policy may guarantee a certain level of performance to a data flow. For example, a required bit rate, delay, jitter, packet dropping probability and/or bit error rate may be guaranteed. If such a policy exists, then the policy is applied. The QoS dynamic execution engine in the commonly owned U.S. Patent Publication 2013/0097350 is incorporated herein by reference and may be used to implement QoS operations. The packet priority processor in commonly owned U.S. Patent Publication 2013/0100812 is incorporated herein by reference and may also be used to implement packet processing operations. The packet traffic control processor in commonly owned U.S. Patent Publication 2013/0107711 is incorporated herein by reference and may also be used to implement packet processing operations.

The VC/SR may also be configured to check for a TCP offload policy. If such a policy exists, then the offload policy is applied. The TCP offload policy may be applied with a TCP Offload engine (TOE). A TOE offloads processing of the entire TCP/IP stack to a network controller. The TCP offload is on a per virtual machine basis. Today, TCP offload is not virtualized. Instead a TOE on a network interface card assumes that one TCP stack is running because there is only one operating system running In contrast, with the disclosed technology the VC/SR has a number of virtual networks or virtual ports 212, which means that there are an equivalent number of TCP stacks running

The VC/SR may also be configured to check for a Secure Socket Layer (SSL) offload policy. If such a policy exists, then the offload policy is applied. For example, the VC/SR may include hardware and/or software resources to encrypt and decrypt the SSL traffic. In this case, the virtualized switch resource terminates the SSL connections and passes the processed traffic to the virtualized computation resource.

Thus, the invention incorporates TOR-type switching operations into individual semiconductors with virtualized computation and switching resources. A VC/SR may be configured for software defined networking (SDN) operations. With this architecture, external TOR switches may be omitted. Further, separate VNIC controllers are not required. Traffic latency may be reduced since packets may be handled with fewer hops, potentially on the same semiconductor or blade resource. Advantageously, on-chip data paths may have larger bandwidths than off-chip connections. The VC/SR may provide better bandwidth and QoS management since the switch has the potential for immediate and direct control over packets.

In one embodiment physical port 310 of the virtualized switch resource is an Ethernet port or multiple Ethernet ports. A Media Access Controller (MAC) performs standard IEEE 802 framing on the packet and extracts the packet data. In one embodiment this interface includes a physical (PHY) layer MAC. In other embodiments this is Infiniband or another physical layer or data link layer (layer-2) protocol. In another embodiment the MAC also detects IEEE PAUSE and PFC flow control packets and notifies all agents (TNS/VNIC below) of forward and back pressure.

Packet data may then enter an on-chip network switch (TNS), such as virtual switch 308. Like a TOR switch, this switch can optionally parse the packets, optionally police them, optionally buffer them, optionally de-encapsulate various protocols (e.g., 802.1 VLAN/NVGRE/VXLAN), optionally perform edits on the packet, such as VLAN insertion, optionally shape them, optionally provide QoS, optionally increment statistics, and drop, multicast or broadcast the packet either to an outbound Ethernet MAC or to a VNIC. The TNS may subsume the role of a virtual switch or a virtual switch may still exist in hypervisor software. In one embodiment this is a hardware device, in another embodiment it may be a network processor. In another embodiment, the TNS may be bypassed or put into a low-power and/or low-latency mode to improve power/performance. Advantageously, the TNS may be programmed using an Application Program Interface (API) as either a typical switch, router, or SDN.

Packets that are sent from the TNS into the VNIC are processed similar to a standard network interface card. Namely, packets are Direct Memory Accessed (DMAed) into memory based receive rings for handling by a general purpose processor. Alternately, the packets are buffer allocated and scheduled if the VNIC has a network processor interface. One advantage of this design is that in one embodiment the parse information determined from the switch can be used for determining where the packet layers are, eliminating the need for the VNIC to also parse. In one embodiment, the TNS can be used to extract the VLAN and/or determine which receive queue gets the packet. In another embodiment slow-path and exception packets are handled by a special VNIC queue.

The on-chip processor handles the packet. In one embodiment, the processor may also be used to handle TNS management tasks and/or switch slow-path packets, either using dedicated generic on-chip cores or under a separate virtualized processor operating system.

The VNIC can also transmit packets using standard memory based transmit rings or a network processor command interface. These packets are sent to the TNS, which can then switch them to another VNIC or Ethernet MAC, just as in the inbound MAC case described above. In one embodiment, the TNS and/or MACs may send shaping and back pressure information to the VNIC so that the packets selected for transmission are optimal for QoS.

Thus, the disclosed VC/SR provides computation resources embedded with a virtualized switch. This architecture provides performance benefits for any computer networking system that is running under virtualization or uses a network switch that is virtualized. The virtualized switch resources implement standard data link layer (layer 2) and network layer (layer 3) processing. The switching resources are virtualized and otherwise support software defined networking.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A semiconductor substrate, comprising:
a processor configurable to support execution of a hypervisor controlling a set of virtual machines; and
a physical switch configurable to establish virtual ports to the set of virtual machines.

2. The semiconductor substrate of claim 1 wherein the physical switch is configurable to support data link layer processing.

3. The semiconductor substrate of claim 1 wherein the physical switch is configurable to support network layer processing.

4. The semiconductor substrate of claim 1 wherein the physical switch is configurable to support a software defined networking switch.

5. The semiconductor substrate of claim 1 wherein the physical switch switches between virtual machines through a virtual-to-physical interface.

6. The semiconductor substrate of claim 1 wherein the physical switch performs packet encapsulation and decapsulation to implement software defined networking.

7. The semiconductor substrate of claim 1 wherein the physical switch selectively performs data policing tasks, data shaping tasks, quality of service provisioning and bandwidth provisioning.

8. The semiconductor substrate of claim 1 wherein the physical switch performs data filtering and implements a firewall for virtual machines.

9. The semiconductor substrate of claim 1 further comprising external network ports.

10. The semiconductor substrate of claim 1 further comprising chip-to-chip ports.

11. The semiconductor substrate of claim 1 further comprising mass storage ports.

12. The semiconductor substrate of claim 11 wherein the mass storage ports are Serial Advanced Technology Attachment (SATA) ports.

13. The semiconductor substrate of claim 1 further comprising bus interface ports.

14. The semiconductor substrate of claim 13 where the bus interface ports are Peripheral Component Interconnect Express ports.

15. A semiconductor substrate, comprising:
a processor configurable to support execution of a hypervisor controlling a set of virtual machines; and
a physical switch configurable to establish virtual ports to the set of virtual machines, wherein the physical switch switches between virtual machines through a virtual-to-physical interface and the physical switch implements network traffic processing tasks.

16. The semiconductor substrate of claim 15 wherein the network traffic processing tasks include packet encapsulation and decapsulation to implement software defined networking.

17. The semiconductor substrate of claim 15 wherein the network traffic processing tasks are selected from data policing tasks, data shaping tasks, quality of service provisioning and bandwidth provisioning.

18. The semiconductor substrate of claim 15 wherein the network traffic processing tasks are selected from data filtering and virtual machine firewall provisioning.

19. A rack, comprising:
a plurality of blade resources, wherein each blade resource has a plurality of semiconductor resources, wherein each semiconductor resource includes a semiconductor substrate with:
a processor configurable to support execution of a hypervisor controlling a set of virtual machines; and
a physical switch configurable to establish virtual ports to the set of virtual machines.

20. The rack of claim 19 wherein the physical switch is configurable to support data link layer processing and network layer processing.
